(19) United States
(12) Patent Application Publication
(10) Pub. No.: US 2007/0068085 A1
(43) Pub. Date: Mar. 29, 2007

(54) Glass run for automobile

(75) Inventors: Ikuo Ninomiya, Aichi-ken (JP); Masahiro Nozaki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 11/527,397

(22) Filed: Sep. 27, 2006

(30) Foreign Application Priority Data
Sep. 28, 2005 (JP) P-2005-281529

(51) Int. Cl. E06B 7/16

(52) U.S. Cl. 49/489.1

(57) ABSTRACT

In a glass run for an automobile having an extruded portion and a corner molded portion so as to be mounted in a corner portion of a door frame, the glass run includes an exterior side wall, an interior side wall, and a bottom wall to thereby be formed into substantially a U-shaped cross section, and a corner bulge portion is provided on an interior side of an interior side wall of a corner molded portion of the glass run, the corner bulge portion having an insert of a material which is harder than the glass run embedded therein so as to enhance the rigidity thereof, for contact with a hollow seal portion of an opening weather strip which is mounted on a corner portion on a peripheral portion of a vehicle body opening when a vehicle door is closed.

### BACKGROUND OF THE INVENTION

1. Field of the Invention

The present invention relates to a glass run for an automobile which is mounted along an inner part of a door frame of a vehicle door.

2. Description of Related Art

As shown in FIG. 10, a glass run 110 is mounted on a door frame 2 of a vehicle door 1 along an inner part thereof for guiding a window glass 5 which moves up and down in the door frame 2. A conventional mounting construction of the glass run is shown in FIGS. 9 to 12.

FIG. 9 is a perspective view of a corner portion 2b of the door frame 2. FIG. 10 is a side view of the vehicle door 1.

FIG. 11 is a sectional view taken along the line C-C in FIG. 10. FIG. 12 is a diagram showing another conventional mounting construction in which a trim 7 is mounted on the door frame 2 so as to hold the glass run 110 by part of the trim 7.

Conventionally, the glass run 110 is mounted within a channel 3 of the door frame 2 as shown in FIGS. 10, 11, so as to seal a gap between the window glass 5 and the door frame 2 as well as guide the window glass 5 which moves up and down in a window glass opening which is defined on an inner circumferential side of the door frame 2. Furthermore, in the glass run 110, an upper side portion and front and rear vertical side portions, which are provided with rectilinear extruded portions 111 formed by extrusion molding, are connected together by corner molded portions 112, which are molded in such a manner that the extruded portions 111 connected by the corner molded portions 112 are formed into the shape of the door frame 2.

In addition, as shown in FIG. 11, sealing between the door 1 and a vehicle body is effected by a door weather strip 108 which is mounted on an outer periphery of the door frame 2 and/or an opening weather strip 109 which is mounted on a flange of a door opening portion. The opening weather strip 109 effects the aforesaid sealing by bringing a hollow seal portion thereof into contact with an interior side surface of a bulge portion 2g on an inner panel 2d of the door frame 2 when the door 1 is closed.

As is shown in FIG. 11, the glass run 110 includes an exterior side wall 120, an interior side wall 130 and a bottom wall 140 to thereby be formed into substantially a U-shaped cross section. An exterior seal lip 150 is provided so as to extend from the vicinity of a distal portion of the exterior side wall 120 toward an inside of the U-shaped cross section. In addition, an interior seal lip 160 is provided so as to extend from the vicinity of a distal portion of the interior side wall 130 toward the inside of the U-shaped cross section. Furthermore, a exterior cover lip 124 is provided so as to extend from the distal portion of the exterior side wall 120 toward the bottom wall 140 along an exterior surface on an exterior side of the exterior side wall 120, and an interior cover lip 134 is provided so as to extend from the distal portion of the interior side wall 130 along an exterior surface on an interior side of the interior side wall 130 (for example, refer to JP-A-4-260814 and Japanese Patent No. 2607972).

The exterior side wall 120, the interior side wall 130 and the bottom wall 140 are inserted into the channel 3 provided in the door frame 2, and respective exterior surfaces of the walls are then brought into contact with interior surfaces of the channel 3. An outer panel 2c of the door frame 2 and one of distal portions of the channel 3 are inserted between the exterior side wall 120 and the exterior cover lip 124, whereas the inner panel 2d and the other distal portion of the channel 3 are inserted between the interior side wall 130 and the interior cover lip 134, whereby the glass run 110 is held in the channel 3.

In addition, as shown in FIG. 9, an upper side portion 2e and a vertical side portion 2f of the door frame 2 are made to contact with each other and are joined to each other in a corner portion 2b of the door 1, and in the channel 3, an upper side portion and a vertical side portion are joined to each other in a similar manner. Due to this, the relevant corner of the door frame 2 is formed into an acute angled shape, and the glass run 110 is molded, at a corner molded portion 112, into an acute angled shape which matches the shape of the corresponding portion of the channel 3.

On the other hand, since the vehicle body is constructed by welding together a plurality of panels which are adapted to make up the vehicle body, the radius of curvature of a corner portion on a peripheral portion 6 of a vehicle body opening in the vehicle body which the door frame 2 comes to face when the door is closed becomes larger than the radius of curvature of the corner portion 2b of the door frame 2. The opening weather strip 109 is mounted on the peripheral portion 6 of the vehicle body opening in the vehicle body so as to seal between the door 1 and the peripheral portion 6 of the vehicle body opening. As has been described above, however, since the radius of curvatures of the corner portion on the peripheral portion 6 of the vehicle body opening in the vehicle body and the corner portion 2b of the door frame differ from each other, the hollow seal portion of the opening weather strip 109 and the bulge portion 2g of the corner portion 2b of the door frame 2 cannot be brought into contact with each other, and due to this, the sealing properties were reduced.

As shown in FIG. 12, the glass run 110 is mounted in the channel 3 of the door frame 2, and a flange 2h is provided on an interior side of the door frame 2, so that the trim 7 is mounted on the flange 2h (for example, refer to JP-A-2001-233060) . Due to this, the hollow seal portion of the opening weather strip 109 can be brought into contact with an interior side surface of the trim 7.

In this case, however, since the trim 7 is also mounted on the door frame 2, the trim 7 is mounted, in the corner portion, such that its radius of curvature becomes smaller than the radius of curvature of the corner portion on the peripheral portion 6 of the vehicle body opening, and hence, the gap could not be filled sufficiently by the trim. In addition, the glass run 110 and the trim 7 need to be produced and mounted on the door frame 2 individually, leading to more labor hours, higher cost and heavier weight.

In addition, there is also proposed a technique in which a block is formed integrally with a portion (a corner molded portion) of a glass run 110 which is mounted on a corner portion 2b of a door frame 2 at the corner molded portion of the glass run 110, so as to be brought into contact with a corner portion of a hollow seal portion of an opening weather strip 109 for sealing. In this case, however, since the corner portion and the block are molded of the same material at the same time, the strength of the block became insufficient, and hence, sufficient sealing properties could not be obtained.

### SUMMARY OF THE INVENTION

The invention is directed to provide a glass run for an automobile which ensures a seal between a peripheral portion of a vehicle body opening in a vehicle body and a hollow seal portion of an opening weather strip in a corner portion of a door frame of an automobile door.

With a view to solving the problem, according to one aspect of the invention, there is provided a glass run adapted to be mounted in an inner part of a door frame of a vehicle door to guide a window glass when the window glass moves up and down, the glass run including:

an extruded portion formed by extrusion molding;

a corner molded portion formed by injection molding so as to be mounted on a corner of the door frame;

an exterior side wall, an interior side wall and a bottom wall so as to form substantially a U-shaped cross section;

an exterior seal lip and an interior seal lip that are provided in the exterior side wall and the interior side wall respectively, extending toward an inside of the U-shaped cross section;

a corner bulge portion provided on an interior side of the interior side wall in the corner molded portion of the glass run; wherein a rigidity of the corner bulge portion is enhanced; and

the corner bulge portion is configured to be brought into contact with a hollow seal portion on an opening weather strip mounted on a corner of a periphery of a vehicle body opening when the vehicle door is closed.

In the above aspect of the invention, the corner bulge portion is provided on the interior side of the interior side wall in the corner molded portion of the glass run, and the corner bulge portion is configured to enhance its rigidity for contact with the hollow seal portion on the opening weather strip mounted in the corner portion on the peripheral portion of the vehicle body opening when the door is closed.

Accordingly, the glass run can be fixed in place in the corner of the door frame at the swollen corner portion assuredly, so as to fill a gap resulting from the difference in radius of curvature between the corner of the door frame and the corner portion on the peripheral portion of the vehicle body opening in the vehicle body to thereby eliminate the gap, whereby a seal therebetween can be secured.

In the invention, since the corner bulge portion is provided on the side of the interior side wall of the corner molded portion of the glass run which lies facing the inside of the vehicle and the corner bulge portion is formed to have the higher rigidity than that of the glass run, the corner bulge portion deforms little and can be fixed to the corner of the door frame assuredly, so that the gap resulting from the difference in radius of curvature between the corner of the door frame and the corner portion on the peripheral portion of the vehicle body opening in the vehicle body can be filled by the corner bulge portion to thereby eliminate the gap for a secure seal.

### BRIEF DESCRIPTION OF THE DRAWINGS

FIG. 1 is a perspective view of a corner molded portion and a corner bulge portion of a glass run of an embodiment of the invention;

FIG. 2 is a cross sectional view of a corner molded portion and a corner bulge portion of a glass run of a first embodiment of the invention, which is taken along the line A-A in FIG. 1.

FIG. 3 is a cross sectional view of a corner molded portion and a corner bulge portion of a glass run of a second embodiment of the invention, which is taken along the line A-A in FIG. 1.

FIG. 4 is a cross sectional view of a corner molded portion and a corner bulge portion of a glass run of a third embodiment of the invention, which is taken along the line A-A in FIG. 1.

FIG. 5 is a cross sectional view of a corner molded portion and a corner bulge portion of a glass run of a fourth embodiment of the invention, which is taken along the line A-A in FIG. 1.

FIG. 6 is a cross sectional view of a corner molded portion and a corner bulge portion of a glass run of a sixth embodiment of the invention, which is taken along the line A-A in FIG. 1.

FIG. 7 is a cross sectional view of an extruded portion of the glass run of the embodiment of the invention.

FIG. 8 is a perspective view of a vehicle.

FIG. 9 is a perspective view of a corner portion of a door frame.

FIG. 10 is a side view of the door of the vehicle.

FIG. 11 is a diagram showing a conventional mounting relationship of weather strips on the door frame.

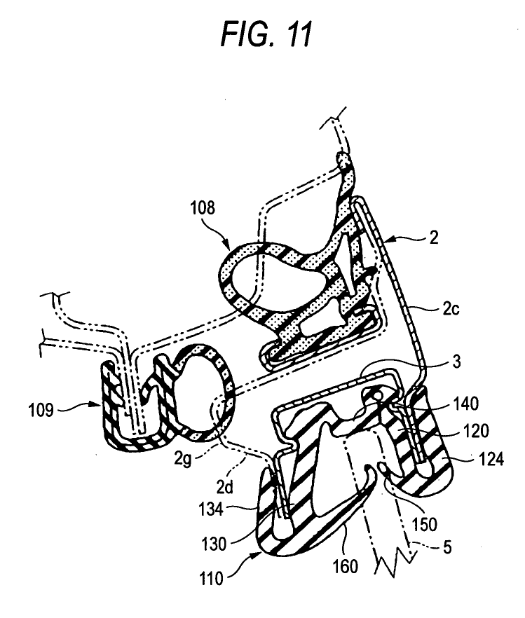

FIG. 12 is a perspective view of a corner molded portion of another conventional glass run.

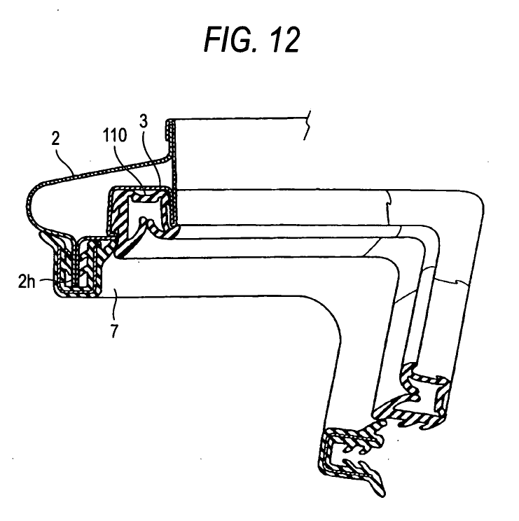

### DETAILED DESCRIPTION OF THE PREFERRED EMBODIMENTS

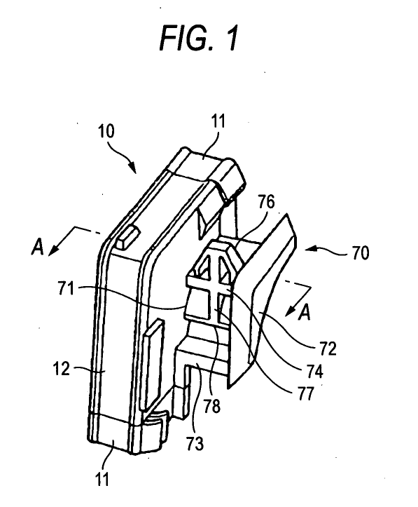

Embodiments of the invention will be described based on FIGS. 1 to 10.

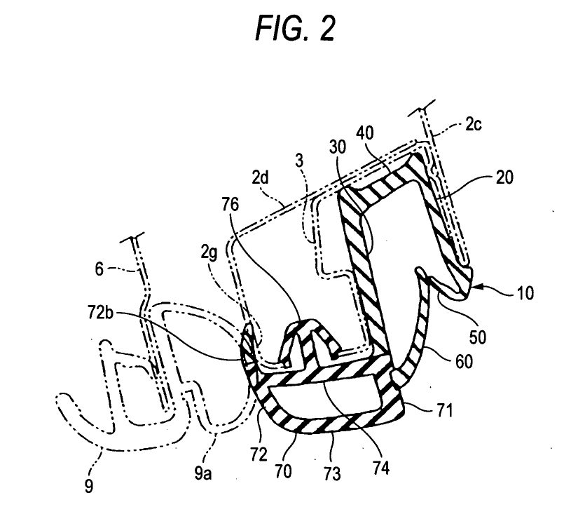

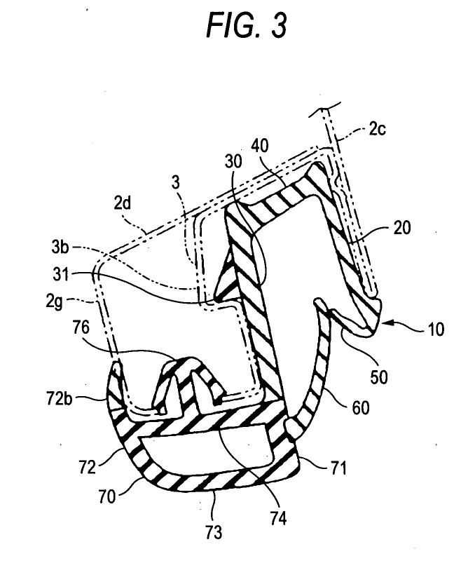

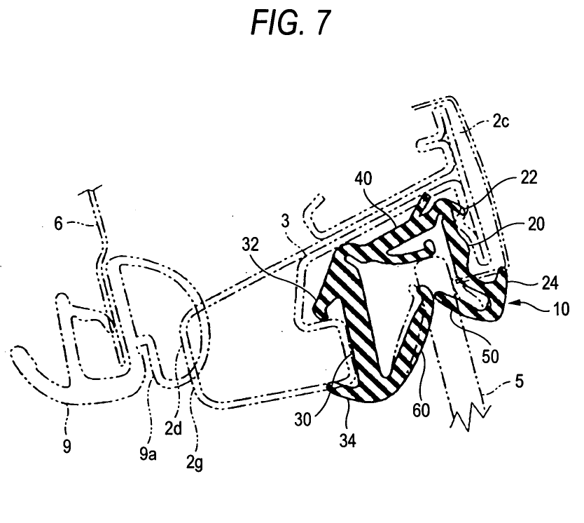

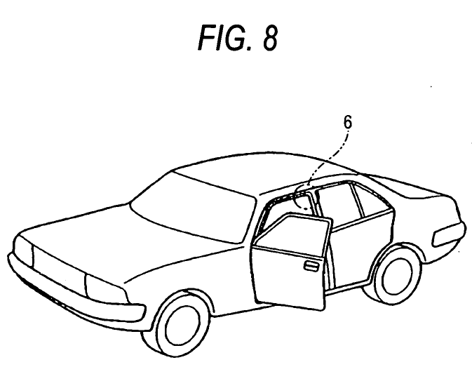

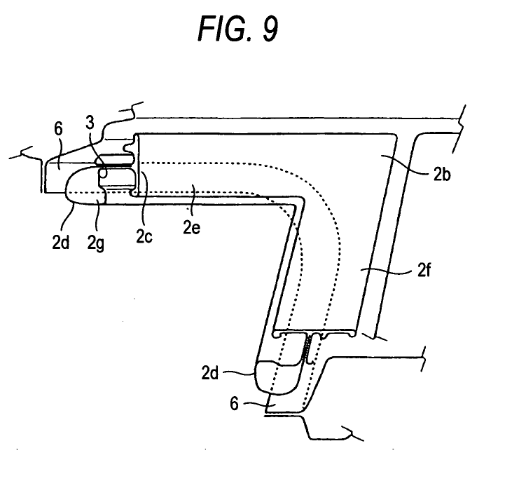

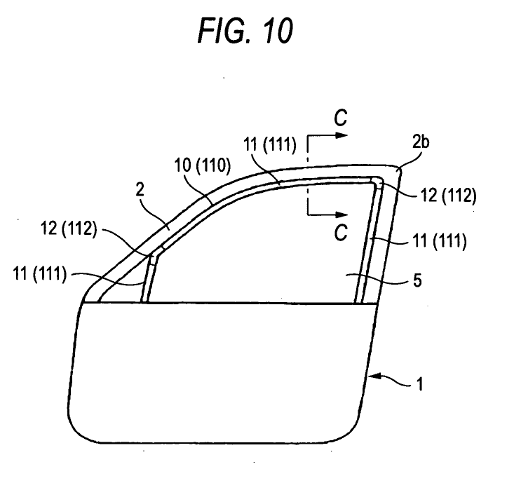

FIG. 10 is a side view of a vehicle door 1. FIG. 1 is a perspective view of a corner molded portion 12 and a corner bulge portion 70 of a glass run 10 according to an embodiment of the invention. FIG. 2 is a cross sectional view taken along the line A-A in FIG. 1. FIGS. 3 to 6 are cross sectional views taken along the line A-A in FIG. 1 which show, respectively, other embodiments of the invention. FIG. 7 is a cross sectional view of an extruded portion of the glass run 10 which is basically similar over the embodiments of the invention. FIG. 8 is a perspective view of a vehicle, and FIG. 9 is a perspective view of a corner portion of a door frame 2.

As shown in FIG. 10, a door frame 2 is provided in an upper part of a vehicle door 1, and a window glass 5 is mounted so as to freely move up and down in the door frame 2. Namely, the window glass 5 and a glass run 10 are provided in a window glass opening portion defined by an inner part of the door frame, and the glass run 10 guides the window glass 5 when it moves up and down, as well as sealing between the window glass 5 and the door frame 2.

The glass run 10 is provided with substantially rectilinear extruded portions 11 which are formed by extrusion molding as a whole and corner molded portions 12 which are mounted in corner portions of the door frame 2 and are formed by injection molding while connecting the extruded portions 11 together.

The extruded portions 11 are provided with an upper side portion which is mounted on an upper side of the door frame 2, a vertical side portion which is mounted on a rear vertical side of the door frame 2 and a vertical side portion which is mounted on a front vertical side of the door frame 2. The upper side portion of the door frame 2 is formed to be inclined downward toward the front of the vehicle on a front side of the door to thereby form an obtuse angle with the front vertical side portion. As shown in FIG. 2 and the like, a channel 3 having a substantially U-shaped cross section is provided in the door frame 2 so that the glass run 10 is mounted therein.

In the glass run 10, the corner molded portions 12 are formed by being molded so as to connect those extruded portions 11 together at corner molded portions of the glass run 10 so that a resulting shape matches the shape of the door frame 2, and the corner molded portion 12 of the glass run 10 constitutes a portion to be mounted in a corner portion 2b of the door frame 2.

As shown in FIG. 9, the channel 3 is provided in the corner portion 2b of the door frame 2, and the corner molded portion of the glass run 10 is held within the channel 3 which resides in an interior defined by an outer panel 2c and an inner panel 2d of the door frame 2.

The shape of a cross section of the extruded portion 11 of the glass run 10 which is mounted on the upper side of the door frame 2 is formed into substantially a U-shape which is defined by an exterior side wall 20, an interior side wall 30 and a bottom wall 40 of the glass run 10, as shown in FIG. 7. FIG. 7 is a cross sectional view taken along the line C-C in FIG. 10.

The glass run 10 has basically substantially similar U-shaped cross sections at the portions which are mounted on the upper side portion and the vertical side portions of the door frame 2.

An exterior seal lip 50 is provided so as to extend from a distal portion of the exterior side wall 20 toward an inside of the U-shaped cross section. In addition, an exterior cover lip 24 is provided so as to cover an exterior side edge of the channel 3 of the door frame 2 at the distal portion of the exterior side wall 20. An interior seal lip 60 is provided so as to extend from a distal portion of the interior side wall 30 toward the inside of the U-shaped cross section, and an interior cover lip 34 is provided so as to cover an interior side edge of the channel 3 of the door frame 2 at the distal portion of the interior side wall 30 except at the corner molded portions.

An exterior holding lip 22 is provided in the vicinity of a root of the exterior side wall 20 which lies close to a portion where the exterior side wall 20 continues to the bottom wall 40. This exterior holding lip 22 is brought into contact with a stepped portion on the channel 3 which is folded back from the outer panel 2c so as to establish a seal with an inner surface of the channel 3. Furthermore, the exterior holding lip 22 is locked on to the stepped of the outer panel 2c so as to prevent the dislodgement of the glass run 10 out of the channel 3.

The interior side wall 30 and the interior seal lip 60 are formed so as to slope longer and become thicker than the exterior side wall 20 and the exterior seal lip 50. Due to this, the window glass 5 can be positioned close to the outside of the vehicle, so as to reduce a difference in level between the window glass 5 and the door frame 2.

Due to this, air drag and wind noise can be reduced, and a preferred effect can be provided from the view point of vehicle design.

As has been described above, the interior cover lip 34 is formed continuously along the distal portion of the interior side wall 30 except at the corner molded portions. The interior cover lip 34 covers a portion where the channel 3 continues to the inner panel 2d on the upper side portion and the vertical side portions of the door frame so as to enhance an appearance from an inside of a passenger compartment.

An exterior holding lip 32 is provided so as to extend from the interior side wall 30. Since an interior side wall of the channel 3 has a bent portion, when the glass run 10 is mounted therein, the interior holding lip 32 is locked in the bent portion, so as to prevent the dislodgement of the interior side wall 30 of the glass run 10 out of the channel 3. In addition, the interior holding lip 32 is brought into contact with the bent portion of the channel 3 so as to seal between the channel 3 and the glass run 10 as well as hold the glass run 10.

A low sliding-resistant member formed of a polyethylene resin, a urethane resin, a silicone resin, an olefin-based thermoplastic elastomer and the like, for example, is formed on surfaces of the exterior seal lip 50 and the interior seal lip 60 which are brought into contact with the window glass 5. Due to this, when the window glass 5 slides within the glass run 10, a sliding resistance that is produced then can be reduced. In addition, as a result of the reduction in sliding resistance against the window glass 5, the deviation of the glass run 10 from the channel 3 can also be prevented.

In addition, the low sliding-resistant member may be formed on an inner surface of the exterior side wall 20 and a rear surface of the exterior seal lip 50. As this occurs, a secure joining between the exterior seal lip 50 and the exterior side wall 20 can be prevented.

As on the exterior seal lip 50 and the interior seal lip 60, a low sliding-resistant member formed of a urethane resin, for example, is formed on an inner surface of the U-shaped cross section which corresponds to the bottom wall 40. Due to this, a sliding resistance between the relevant portion and the window glass 5 can also be reduced.

Next, the corner molded portion 12 of the glass run 10 will be described.

As is shown in FIG. 9, in the door frame 2, the upper side portion is formed substantially horizontally at the rear corner portion 2b of the automotive door, while the vertical side portion is formed slightly inclined toward the rear, and the upper side portion and the vertical side portion are joined together so as to contact with on each other to thereby form an acute angle therebetween. The channel 3 is provided within the rear corner portion 2b of the door frame 2, and as with the door frame 2, in the channel 3, a vertical side portion and an upper side portion are joined together so as to form an acute angle.

As is shown in FIGS. 1 and 10, the corner molded portion 12 of the glass run 10 is formed by injection molding into a shape which matches the shape of the corner portion 2b of the door frame so as to connect together the extruded portions 11 mounted on the upper side portion and the vertical side portion of the door frame 2 into a shape which matches the shape of the door frame 2. In addition, the corner molded portion 12 has a corner bulge portion 70 formed integrally on an interior side of the interior side wall 30.

Note that the corner bulge portion 70 of the invention is formed integrally with the corner molded portion 12 of the glass run 10 on one occasion and is formed separately from the corner molded portion 12 on another occasion. Hereinafter, the corner bulge portion 70 will be described as being formed integrally with the corner molded portion 12.

A first embodiment of the invention will be described based on FIGS. 1 and 2.

FIG. 1 is the perspective view of the corner molded portion 12 and the corner bulge portion 70 of the glass run 10, and FIG. 2 is the sectional view of the corner molded portion 12 and the corner bulge portion 70 of the glass run 10 which is taken along the line A-A in FIG. 1.

The corner molded portion 12 of the glass run 10 is formed so as to be mounted in the corner portion 2b of the door frame 2, and as is shown in FIG. 2, as with the extruded portion shown in FIG. 7, the corner molded portion 12 is provided with an exterior side wall 20, an inside side wall 30 and a bottom wall 40 to thereby be formed into substantially a U-shaped cross section. Although the cross sections of the extruded portions 11 which make up the upper side portion and the vertical side portion are slightly different from each other, the upper side portion and the vertical side portion are connected to each other by changing the difference continuously at the corner molded portion 12. In addition, as with the extruded portion 11, an interior seal lip 60 and an exterior seal lip 50 are provided so as to extend from the interior side wall 30 and the exterior side wall 20, respectively, toward an inside of the glass run 10.

A distal end portion of the interior side wall 30 of the corner molded portion 12 is made to extend inward from a corner portion of the corner, and the corner bulge portion 70 is formed inward from a distal portion of the interior side wall 30 so extended. Distal portions of the extruded portions 11, that is, the upper side portion and the vertical side portion, of the glass run are held in a mold for molding the corner molded portion 12. The corner molded portion 12 and the corner bulge portion 70 are molded integrally by a single mold. Then, when the corner molded portion 12 and the corner bulge portion 70 are molded, the corner molded portion 12 and the upper side portion and the vertical side portion of the extruded portions 11 are joined together by virtue of vulcanized bonding or thermal welding. In addition, as will be described later on, the corner bulge portion 70 and the corner molded portion 12 can be molded separately using different molds.

The inside wall 30 of the corner molded portion 12 is formed longer than the exterior side wall 20, and an interior seal lip 60 is provided along a distal portion of the interior side wall 30 so as to extend therefrom. By forming the corner molded portion 12 in this way, when the window glass 5 moves up and the end portion of the window glass 5 intrudes into an interior of the U-shaped cross section of the glass run 10, the end portion of the window glass 5 also intrudes into an interior of the corner molded portion 12, whereby, as in the extruded portion, the end portion of the window glass 5 can be sealed by the interior seal lip 60 and the exterior seal lip 50.

As has been described above, the corner bulge portion 70 is formed on the corner molded portion of the glass run 10. As is shown in FIGS. 1 and 2, the corner bulge portion 70 is provided with an exterior side wall 71, an interior side wall 72 and a lower wall 73 to thereby be formed into substantially a U-shaped cross section. The exterior side wall 71 is provided so as to extend from the distal portion of the interior side wall 30 of the corner molded portion 12 substantially in a direction in which the interior side wall 30 extends. The lower wall 73 is formed so as to bend from a distal portion of the exterior side wall 71 substantially at right angles to extend toward the inside of the vehicle, and the inside wall 72 is formed from a distal portion of the lower wall 73 so as to extend in substantially parallel to the exterior side wall 71 or in a slightly arc-like shape. A plurality of ribs, for example, a primary rib 77 and a secondary rib 78, are formed between the interior side wall 72 and the exterior side wall 71. One of the ribs may be formed integrally with the lower wall 73 at a lower part thereof. Note that an interior side surface of the interior side wall 72 is formed substantially flush with an interior side surface of a bulge portion of the door frame 2.

In addition, an upper wall 74 is formed parallel to the secondary rib 78.

As is shown in FIG. 1, the exterior side wall 71 and the interior side wall 72 are formed into substantially a triangular shape as the corner bulge portion 70 is projected on a horizontal plane. Bottom sides of the triangular shapes of the exterior side wall and the interior side wall 72 are formed so as to continue to the lower wall 73, and the corner bulge portion. 70 takes the U-shaped cross section as has been described before. The bottom sides of the triangular shapes of the exterior side wall 71 and the interior side wall 72 which constitute the lower wall 73 are formed into a curvilinear shape so as to have substantially the same radius of curvature as that of a corner portion on a peripheral portion of a vehicle body opening in a vehicle body.

The exterior side wall 71 is formed integrally with the interior side wall 30 of the corner molded portion 12 of the glass run 10 and is formed into a shape which matches the distal portion of the interior side wall 30.

The glass run 10 is mounted within the channel 3 of the door frame 2. As this occurs, in the corner molded portion 12, the corner bulge portion 70 is mounted on the inner panel 2d of the door frame 2. Namely, the inner panel 2d of the door frame 2 is made to extend integrally from the channel 3, and a lower surface thereof forms a flat bulge portion 2g. Then, the upper wall 74 of the corner bulge portion 70 is brought into contact with a lower surface of the bulge portion 2g of the inner panel 2d. As is shown in FIGS. 1 and 2, a clip 76 is integrally formed on an upper surface of the upper wall 74. When this clip 76 is mounted in a mounting hole provided in the lower surface of the bulge portion 2g of the inner panel 2d, the corner bulge portion 70 is mounted on the bulge portion 2g. In addition, the clip 76 may be formed separately from the corner bulge portion 70. In place of the clip 76, a pressure sensitive adhesive double coated tap may be attached to the upper surface of the upper wall 74, so that the corner bulge portion 70 can be mounted thereon. When the double coated adhesive tape is used, the necessity of providing the mounting hole in the inner panel 2d can be obviated.

When the corner bulge portion 70 is mounted on the bulge portion 2g of the inner panel 2d, the interior side surface of the bulge portion 2g of the inner panel 2d and the surface of the inside wall 72 of the corner bulge portion 70 forms substantially the same plane. A corner portion of a hollow seal portion 9a of an opening weather strip 9 which is mounted on the peripheral portion 6 of the vehicle body opening is brought into contact with the plane so formed.

Since the radius of curvature of the bottom side portion of the corner bulge portion 70 is substantially the same as the radius of curvature of the corner portion on the peripheral portion 6 of the vehicle body opening in the vehicle body, after the glass run 10 has been mounted on the door 1, the corner bulge portion 70 comes into contact with the corner portion of the hollow seal portion 9a of the opening weather strip 9 when the door is closed so as to establish a seal thereat.

The corner bulge portion 70 is formed of a material which is harder than the corner molded portion 12 of the glass run 10 so as to enhance the rigidity thereof. For example, for the corner molded portion 12, as a hard material, a hard rubber or a hard synthetic resin can be used, and as the hard rubber, an EPDM rubber hardened to JIS HA85 to 95 can be used, while as the hard synthetic resin, an olefin-based thermoplastic elastomer such as hard polyethylene and polypropylene can be used. Furthermore, a hard olefin-based thermoplastic elastomer hardened to JIS HA85 to 95 can be used. Since the materials having the aforesaid hardness are used as the hard materials, the deformation of the corner bulge portion 70 can be prevented even in the event that an insert member is not used.

When molding the corner bulge portion 70 of the door weather strip 10, in the event that its inner skeleton portions are formed of the aforesaid hard materials such as the hard EPDM rubber, the hard polyethylene and the polypropylene, while other portions (for example, a surface portion and a terminal portion) are formed of a soft EPDM rubber or an olefin-based thermoplastic elastomer, an injection molding machine is used, and two hard and soft materials are injected into the cavity to form the corner bulge portion 70.

An inner side wall lip 72b is formed along a distal portion of the interior side wall 72 of the corner molded portion 12. A distal end portion of the inner side wall lip 72b is brought into contact with the surface of the bulge portion 2g of the door frame 2. In addition, the inner side wall lip 72b is formed of a material which is softer than a main body which is part of the other portions of the corner bulge portion 70. Due to this, even in the event that there exist irregularities on the surface of the bulge portion 2g of the door frame 2, the inner side wall lip 72b can be securely joined to the irregular surface therealong, whereby the sealing properties can be enhanced and a good appearance can be provided.

The inner side wall lip 72b can be formed of a soft EPDM rubber or an olefin-based thermoplastic elastomer of JIS HA60 to 80. Due to this, the inner side wall lip 72b can follow the change in the surface configuration of the bulge portion 2g of the door frame 2 and have a sufficient flexibility as well.

Note that the surface of the corner bulge portion 70 can be covered with the soft material of which the inner side wall lip 72b is formed. In this case, a joint portion between the inner side wall lip 72b and the main body of the corner bulge portion 70 can be covered to thereby provide a good appearance.

Next, a second embodiment of the invention will be described based on FIG. 3. The second embodiment differs from the first embodiment in that a projection 31 is provided on an interior side wall 30 of a glass run 10, and a corner molded portion 12 and a corner bulge portion 70 are mounted on a bulge portion 2g of a door frame 2, and the other portions remain the same. Consequently, the description of like points of the second embodiment to those of the first embodiment will be omitted, so that the different points in the second embodiment will mainly be described.

A channel stepped portion 3b is formed on an interior side wall of a channel 3 of a door frame 2. In the second embodiment, an interior side wall projection 31 is formed on an outer surface of an interior side wall 30 of the glass run 10. The interior side wall projection 31 is formed of a hard material as with the corner bulge portion 70. Due to this, when the glass run 10 is mounted in the channel 3, the interior side wall projection 31 is locked in the channel stepped portion 3b.

The corner bulge portion 70 and the glass run 10 are formed integrally, and the corner bulge portion 70 is mounted on the bulge portion 2g of the door frame 2. Due to this, the bulge portion 2g of the door frame 2 can be held by the interior side wall projection 31 and the corner bulge portion 70 therebetween, whereby the corner molded portion 12 of the glass run 10 and the corner bulge portion 70 can be held securely.

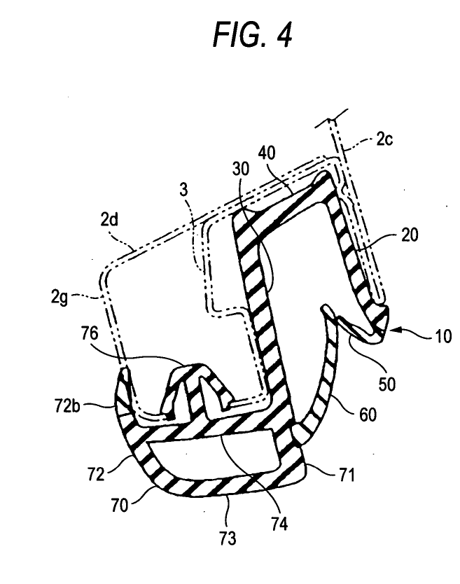

Next, a third embodiment of the invention will be described based on FIG. 4. The third embodiment differs from the first embodiment in that an exterior side wall 20, an interior side wall 30 and a bottom wall 23 of a corner molded portion 12 of a glass run 10 are formed of the same hard material as a corner bulge portion 70, and the other portions remain the same. Consequently, the description of like points of the third embodiment to those of the first embodiment will be omitted, so that the different point in the third embodiment will mainly be described.

In the third embodiment, as is described above, the exterior side wall 20, the interior side wall 30 and the bottom wall 23 of the corner molded portion 12 of the glass run 10 are formed of a hard material integrally with the corner bulge portion 70, and an exterior seal lip 50, an interior seal lip 60 and an inner side wall lip 72b are formed of a soft material.

Due to this, the corner molded portion 12 of the glass run 10 is held in the channel 3 strongly and rigidly, and a bulge portion 2g of a door frame 2 can be held by the interior side wall 30 of the glass run 10 and the corner bulge portion 70 therebetween. In addition, a window glass 5 can be sealed by the exterior seal lip 50 and the interior seal lip 60 assuredly.

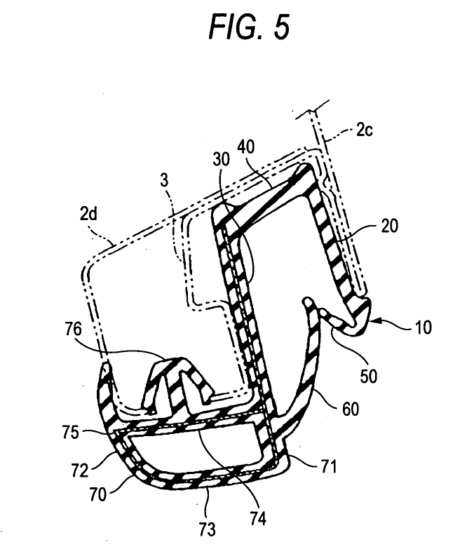

Next, a fourth embodiment of the invention will be described based on FIG. 5. The fourth embodiment differs from the first embodiment in that an insert 75 is embedded in a corner bulge portion 70 and an interior side wall 30 of a glass run 10, and the corner bulge portion 70 is formed of the same soft material as the glass run 10, and the other portions remain the same. Consequently, the description of like points of the fourth embodiment to those of the first embodiment will be omitted, so that the different points in the fourth embodiment will mainly be described.

In the fourth embodiment, as is described above, the insert 75 is embedded in the corner bulge portion 70, and the insert 75 which is embedded in an exterior side wall 71 of the corner bulge portion 70 is made to extend integrally and continuously into an inside of the interior side wall 30 of the glass run 10.

Due to this, even in the event that the corner bulge portion 70 is formed of the same soft material as the glass run 10, the strength of the corner bulge portion 70 can be enhanced (the rigidity of the bulge portion 70 can be increased), so that the corner bulge portion 70 can be fixed to a corner portion 2b of a door frame 2 assuredly. Consequently, since the one type of material is used, molding is facilitated. In addition, since the insert 75 is embedded continuously in the glass run 10 and the corner bulge portion 70, the connection between the glass run 10 and the corner bulge portion 70 can be strengthened.

Note that while the metallic insert 75 is shown in FIG. 5, the insert 75 may be made of a hard resin.

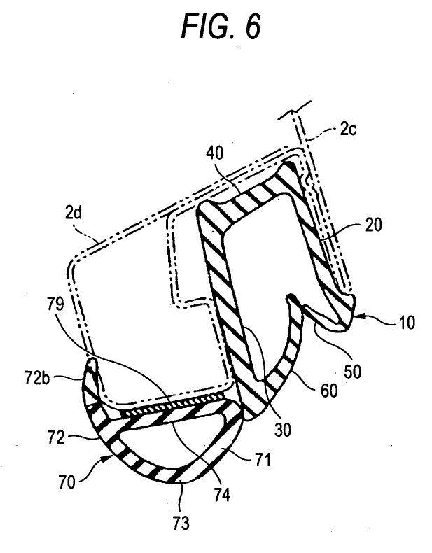

Next, a fifth embodiment of the invention will be described based on FIG. 6. The fifth embodiment differs from the first embodiment in that the shapes of an exterior side wall 71 and a lower wall 73 of a corner bulge portion 70 differ, the corner bulge portion 70 is formed separately from a glass run 10, and the corner bulge portion 70 is bonded to a bulge portion 2g of a door frame 2 with a pressure sensitive adhesive double coated tape 79, and the other portions remain the same. Consequently, the description of like points of the fifth embodiment to those of the first embodiment will be omitted, so that the different points in the fifth embodiment will mainly be described.

In the fifth embodiment, as is described above, the exterior side wall 71 and the lower wall 73 of the corner bulge portion 70 are shaped to slope so as to connect a distal portion of an interior side wall 30 of the glass run 10 to a distal portion of an interior side wall 72 of the corner bulge portion 70. Consequently, the exterior side wall 71 and the lower wall 73 of the corner bulge portion 70 are not formed to be bent at right angles as in the first embodiment but is formed into a single flat surface or curved surface. Due to this, an interior seal lip 60 of the glass run 10 and the exterior side wall 71 and the lower wall 73 of the corner bulge portion 70 can form substantially the same flat plane or curved plane, and a smooth external appearance can be formed.

Note that a distal portion of the exterior side wall 71 of the corner bulge portion 70 and the distal portion of the interior side wall 30 of the corner molded portion 12 of the glass run 10 are in contact with each other to thereby produce no gap therebetween, the sealing properties being thereby secured.

Furthermore, the corner bulge portion 70 and the corner molded portion 12 of the glass run 10 are molded by different molds, respectively, and are mounted on the bulge portion 2g and in the channel 3 of the door frame 2, respectively. Due to this, the constructions of the individual molds are simplified, whereby the molding speed can be increased, the productivity can be enhanced, and the molding cost can be reduced.

In addition, in place of the clip 76, the corner bulge portion 70 is mounted on the bulge portion 2g of the door frame 2 by a pressure sensitive adhesive double coated tape 79. Due to this, the necessity is obviated of providing an insertion hole of the clip 76 in the bulge portion 2g of the door frame 2, the sealing properties being thereby improved.

Next, a manufacturing method of the corner bulge portion 70 and the glass run 10 will be described.

In extruding and molding the glass run 10, synthetic rubbers, thermoplastic elastomers and soft synthetic resins are used as the extruding and molding materials of the extruded portions 11 and the corner molded portions 12, and in the synthetic rubbers, an EPDM rubber, for example, is used, in the thermoplastic elastomers, an olefin-based elastomer, for example, is used, and in the soft synthetic resins, a soft vinyl chloride, for example, is used. When the EPDM rubber and the olefin-based elastomer are used, since they are materials of the same kind, recycling is facilitated.

A straight extruded portion 11 is extruded linearly by an extruder.

When the synthetic rubber is used for extrusion thereof, the extruded portion 11 so extruded is transferred to a vulcanizing tank after extrusion, where the extruded portion 11 is heated by hot air or high-frequency waves to be vulcanized. In the case of the thermoplastic elastomer and the soft synthetic resin, the extruded portion 11 is then cooled to be hardened. Thereafter, the extruded portion 11 is cut to predetermined lengths, whereby the extruded portions are manufactured.

Next, in molding a molded portion to mold a corner molded portion 12 and a corner bulge portion 70, the extruded member that is produced to form the extruded portions 11 in the way described above is cut to predetermined lengths, and end portions of extruded members so cut are held in the mold for molding the molded portion. Then, the material to mold a molded portion is injected into a cavity of the mold. The cross sectional shape of the molded portion is substantially the same as the cross sectional shape of the extruded portion. As the molding materials, the same material as used to form the extruded portion is preferably used to mold the corner molded portion 12, whereas a material which is harder than the material used to form the extruded portion is used to mold the corner bulge portion 70 or an insert is embedded in the corner bulge portion 70 so as to enhance the rigidity thereof. In the case of the thermoplastic elastomer and the soft synthetic resin, since the injected material is molten when it is injected into the mold, the extruded portion is integrally fusion bonded to a molded portion which is being molded by virtue of the heat and pressure of the molten material.

While the corner molded portion 12 of the glass run 10 and the corner bulge portion 70 may be molded in the same mold at the same time as is described above, they may be molded by different molds. When the corner molded portion 12 and the corner bulge portion 70 are molded by the different molds, the constructions of the individual molds are simplified, whereby the molding can be facilitated and the molding cost can be reduced.

In the case of the synthetic rubber, after the material is injected into the mold, the mold is heated for vulcanization. As this occurs, since the extruded portion and the molded portion can be molded of the same material or materials of the same kind and can be vulcanization bonded to each other, the extruded portion and the molded portion are integrally secured to each other. In addition, when the extruded portion is formed of the synthetic rubber, the molded portion can be formed of the thermoplastic elastomer.

As described above, in the invention, the corner bulge portion is provided on the interior side of the interior side wall in the corner molded portion of the glass run, and the corner bulge portion is configured to enhance its rigidity for contact with the hollow seal portion on the opening weather strip mounted in the corner portion on the peripheral portion of the vehicle body opening when the door is closed.

Due to this, the glass run can be fixed in place in the corner of the door frame at the swollen corner portion assuredly, so as to fill a gap resulting from the difference in radius of curvature between the corner of the door frame and the corner portion on the peripheral portion of the vehicle body opening in the vehicle body to thereby eliminate the gap, whereby a seal therebetween can be secured.

According to the invention, the corner bulge portion may be formed of a material which is harder than another part of the glass run to enhance the rigidity.

When the corner bulge portion is formed of the hard material so as to enhance the rigidity thereof, a high shape retainability can be provided. Thus, the corner bulge portion can be brought into contact with the hollow seal portion of the opening weather strip assuredly when the door is closed to thereby ensure a seal therebetween.

According to the invention, the corner bulge portion may have an insert embedded therein.

The corner bulge portion may have the insert embedded in the interior thereof so as to enhance the rigidity. Due to this, even in the event that the corner bulge portion is formed of the same material as that of the glass run, the rigidity (strength) of the corner bulge portion can be increased, and, hence, a strong shape retainability can be provided, so that the glass run can be fixed in place in the corner of the door frame at the corner bulge portion assuredly, so as to fill a gap resulting from the difference in radius of curvature between the corner of the door frame and the corner portion on the peripheral portion of the vehicle body opening in the vehicle body to thereby eliminate the gap, whereby a seal therebetween can be secured.

According to the invention, the corner bulge portion may be formed integrally with the corner molded portion of the glass run so as to extend from the distal portion of the interior side wall in a direction in which the interior side wall extends and in a direction toward an inside of the vehicle so as to cover a lower surface of a bulge portion of the door frame.

The corner molded portion and the corner bulge portion of the glass run can be molded integrally, thereby facilitating the molding, and the lower surface of the corner bulge portion is easily mounted so as to cover the door frame at the same time that the glass run is mounted on the door frame.

According to the invention, the corner bulge portion may be formed separately from the corner molded portion of the glass run so as to be brought into contact with the distal portion of the interior side wall of the glass run in the corner molded portion thereof and is mounted on the bulge portion of the door frame.

Molds for molding the corner molded portion of the glass run and the corner bulge portion are different, and the construction of each of the molds becomes simple, not only the molding speed can be increased but also the molding cost can be reduced.

According to the invention, a surface of the corner bulge portion may be covered by a material which is softer than an interior thereof.

Even in the event that there exists a joint in a main body of the corner bulge portion, the surface thereof can be covered by the soft material, resulting in a superior external appearance.

According to the invention, the corner bulge portion may include an exterior side wall, an interior side wall and a lower wall to thereby be formed into substantially a U-shaped cross section, the exterior side wall being provided so as to extend from the distal portion of the interior side wall of the glass run in the corner molded portion thereof or be brought into contact with the interior side wall, whereas the interior side wall of the corner bulge portion is brought into contact with the hollow seal portion of the opening weather strip mounted in the corner portion on the peripheral portion of the vehicle body opening when the door is closed.

The corner bulge portion can be made hollow, and the weight thereof can be reduced.

In addition, since the exterior side wall of the corner bulge portion extends from the distal portion of the interior side wall of the glass run in the corner molded portion thereof or be brought into contact with the interior side wall, the exterior side wall of the corner bulge portion presents a surface where the interior side wall and the exterior side wall of the glass run continues to each other. Hence, there exists nothing that interrupts moving up and down of the window glass.

In addition, the interior side wall of the corner bulge portion can be brought into contact with the hollow seal portion of the opening weather strip mounted in the corner portion on the peripheral portion of the vehicle body opening when the door is closed at a flat surface thereof. The surface of the interior side wall of the corner bulge portion presents a wide contact area, and therefore, even in the event that there occurs a variation in assembling the glass run, the flat surface of the interior side wall can be brought into contact with the opening weather strip in the corner portion on the peripheral portion of the vehicle body opening assuredly for a seal.

According to the invention, an interior side wall lip may be provided so as to extend from a distal portion of the interior side wall of the corner bulge portion so as to be brought into contact with an interior side wall of the bulge portion of the door frame, the interior side wall lip being formed of a material which is softer than a main body of the corner bulge portion.

The interior side wall lip can securely be joined to the surface of the bulge portion of the door frame, whereby the sealing properties can be increased, and a better external appearance can be provided.

According to the invention, the exterior side wall and the interior side wall of the corner bulge portion may be formed into substantially a triangular shape as projected on a horizontal plane, and a bottom side of the triangular shape may continue to the lower wall of the corner bulge portion and may have substantially the same radius of curvature as a radius of curvature of the corner portion on the peripheral portion of the vehicle body opening, and the exterior side wall may have a shape which allows the exterior side wall to integrally continue to or contact with the distal portion of the interior side wall of the glass run in the corner molded portion thereof.

The shape of the corner bulge portion which is mounted in the corner molded portion of the glass run and the shape of the corner portion on the peripheral portion of the vehicle body opening are almost the same, and therefore, the aforesaid gap produced due to the difference in radius of curvature can be sealed by the corner bulge portion.

Since the bottom side of the triangular shape continues to the lower wall of the corner bulge portion and has substantially the same radius of curvature as the radius of curvature of the corner portion on the peripheral portion of the vehicle body opening, the bottom side of the corner bulge portion can be positioned along the corner portion on the peripheral portion of the vehicle body opening.

The exterior side wall has the shape which allows the exterior side wall to integrally continue to or contact with the distal portion of the interior side wall of the glass run in the corner molded portion thereof. Due to this, when the corner bulge portion is mounted, the distal portion of the interior side wall of the glass run and the exterior side wall of the corner bulge portion can form the same plane, so that the gap between the glass run and the corner bulge portion can be sealed but also the window glass is allowed to move up and down smoothly.

According to the invention, the corner bulge portion may be mounted on a surface of the bulge portion of the door frame which lies on a side facing a window glass opening in the door frame by a clip or a double coated adhesive tape.

When the glass run is mounted on the door frame, the glass run can be fixed to the door frame easily and securely by only pressing the corner bulge portion against the door frame.

In addition, when the corner bulge portion is secured to the relevant surface of the bulge portion of the door frame using the double coated adhesive tape, there is no need to provide a clip mounting hole in the door frame, whereby the sealing properties can be increased by such an extent that no clip mounting hole is provided.

According to the invention, the corner bulge portion may includes an exterior side wall, an interior side wall and a lower wall to thereby be formed into substantially a U-shaped cross section, the exterior side wall being formed integrally from the distal portion of the interior side wall of the glass run in the corner molded portion thereof or being joined to the distal portion of the interior side wall so as to extend in a direction in which the exterior side wall extends, and the interior side wall of the corner bulge portion may be formed on substantially the same plane as an interior side surface of the bulge portion of the door frame.

The corner bulge portion can be made hollow, and hence, the weight thereof can be reduced.

Since the exterior side wall of the corner bulge portion is formed integrally from the distal portion of the interior side wall of the glass run in the corner molded portion thereof or is joined to the distal portion of the interior side wall so as to extend in the direction in which the exterior side wall extends, when the corner bulge portion is mounted, the distal portion of the interior side wall of the glass run and the exterior side wall of the corner bulge portion can form substantially the same plane, and therefore, there exists nothing that interrupts moving up and down of the window glass.

According to the invention, the corner bulge portion may have a plurality of ribs formed in an interior of the U-shaped cross section for connecting the exterior side wall, the interior side wall and the lower wall together.

The exterior side wall and the interior side wall can be held flexibly while the U-shaped cross section is maintained, and the interval between the exterior side wall and the interior side wall can be maintained, whereby the sealing properties between the opening weather strip and the corner bulge portion can be increased.

According to the invention, an interior of the corner bulge portion may be formed of an olefin-based hard synthetic resin such as polyethylene or polypropylene.

The clip with which the corner bulge portion is mounted on the bulge portion of the door frame and the ribs can be formed integrally, and the clip and ribs can be formed at the same time as the formation of the corner bulge portion.

According to the invention, the exterior side wall and the lower wall of the corner bulge portion may be formed into a slope so as to connect the distal portion of the interior side wall of the glass run to the distal portion of the interior side wall of the corner bulge portion.

The interior seal lip of the glass run and the exterior side wall and the lower wall of the corner bulge portion can form substantially the same plane, and even in the event that a end portion of the window glass oscillates, the end portion of the window glass can be guided into the interior of the glass run, and a smooth external appearance can be formed.

According to the invention, the extruded portion of the glass run may be formed of an EPDM rubber or an olefin-based thermoplastic elastomer, and the corner molded portion and the corner bulge portion of the glass run may be formed of an olefin-based thermoplastic elastomer.

The extruded portion of the glass run exhibits a good weatherability, the corner molded portion and the corner bulge portion of the glass run do not need to be vulcanized, and they can easily be molded and also have flexibility. Furthermore, since the extruded portion and the corner molded portion of the glass run are formed of the same olefin-based material, a product can be obtained which is good in adhesion and weatherability and can easily be recycled for reuse.

Note that while the embodiments are described as the clip being molded integrally of the same material as used in molding the corner bulge portion 70, the clip may be molded separately of the synthetic resin, and furthermore, a resin plate including a clip portion may be insert molded in the corner bulge portion when the corner bulge portion is molded.

What is claimed is:

1. A glass run adapted to be mounted in an inner part of a door frame of a vehicle door to guide a window glass when the window glass moves up and down, the glass run comprising:
an extruded portion formed by extrusion molding;
a corner molded portion formed by injection molding so as to be mounted on a corner of the door frame;
an exterior side wall, an interior side wall and a bottom wall so as to form substantially a U-shaped cross section;
an exterior seal lip and an interior seal lip that are provided in the exterior side wall and the interior side wall respectively, extending toward an inside of the U-shaped cross section;
a corner bulge portion provided on an interior side of the interior side wall in the corner molded portion of the glass run; wherein a rigidity of the corner bulge portion is enhanced; and
the corner bulge portion is configured to be brought into contact with a hollow seal portion on an opening weather strip mounted on a corner of a periphery of a vehicle body opening when the vehicle door is closed.

2. A glass run according to claim 1, wherein the corner bulge portion is formed of a material which is harder than another part of the glass run.

3. A glass run according to claim 1, wherein the corner bulge portion has an insert embedded therein.

4. A glass run according to claim 1, wherein the corner bulge portion is formed integrally with the corner molded portion of the glass run so as to extend from the distal portion of the interior side wall in a direction in which the interior side wall extends and in a direction toward an inside of the vehicle so as to cover a lower surface of a bulge portion of the door frame.

5. A glass run according to claim 1, wherein the corner bulge portion is formed separately from the corner molded portion of the glass run so as to be brought into contact with the distal portion of the interior side wall of the glass run in the corner molded portion thereof and is mounted on a bulge portion of the door frame.

6. A glass run according to claim 1, wherein a surface of the corner bulge portion is covered by a material which is softer than an interior thereof.

7. A glass run according to claim 1, wherein the corner bulge portion comprises an exterior side wall, an interior side wall and a lower wall to thereby be formed into substantially a U-shaped cross section, the exterior side wall being provided so as to extend from the distal portion of the interior side wall of the glass run in the corner molded portion thereof or be brought into contact with the interior side wall, and
the interior side wall of the corner bulge portion is brought into contact with the hollow seal portion of the opening weather strip mounted in the corner portion on the peripheral portion of the vehicle body opening when the door is closed.

8. A glass run according to claim 7, wherein an interior side wall lip is provided so as to extend from a distal portion of the interior side wall of the corner bulge portion to be brought into contact with an interior side wall of the bulge portion of the door frame, the interior side wall lip being formed of a material which is softer than a main body of the corner bulge portion.

9. A glass run according to claim 7, wherein the exterior side wall and the interior side wall of the corner bulge portion are formed into substantially a triangular shape as projected on a horizontal plane, and
wherein a bottom side of the triangular shape continues to the lower wall of the corner bulge portion and has substantially the same radius of curvature as a radius of curvature of the corner portion on the peripheral portion of the vehicle body opening, and the exterior side wall has a shape which allows the exterior side wall to integrally continue to or contact with the distal portion of the interior side wall of the glass run in the corner molded portion thereof.

10. A glass run for automobile according to claim 1, wherein the corner bulge portion is mounted on a surface of a bulge portion of the door frame which lies on a side facing a window glass opening in the door frame by a clip or a double coated adhesive tape.

11. A glass run for automobile according to claim 1, wherein the corner bulge portion comprises an exterior side wall, an interior side wall and a lower wall to thereby be formed into substantially a U-shaped cross section, the exterior side wall being formed integrally from the distal portion of the interior side wall of the glass run in the corner molded portion thereof or being joined to the distal portion of the interior side wall so as to extend in a direction in which the exterior side wall extends, whereas the interior side wall of the corner bulge portion is formed on substantially the same plane as an interior side surface of the bulge portion of the door frame.

12. A glass run for automobile according to claim 1, wherein the corner bulge portion has a plurality of ribs formed in an interior of the U-shaped cross section for connecting the exterior side wall, the interior side wall and the lower wall together.

13. A glass run for automobile according to claim 1, wherein an interior of the corner bulge portion is formed of an olefin-based hard synthetic resin such as polyethylene or polypropylene.

14. A glass run for automobile according to claim 1, wherein the exterior side wall and the lower wall of the corner bulge portion are formed into a slope so as to connect the distal portion of the interior side wall of the glass run to the distal portion of the interior side wall of the corner bulge portion.

15. A glass run for automobile according to claim 1, wherein the extruded portion of the glass run is formed of an EPDM rubber or an olefin-based thermoplastic elastomer, and the corner molded portion and the corner bulge portion of the glass run are formed of an olefin-based thermoplastic elastomer.
